(19) United States
(12) Patent Application Publication
(10) Pub. No.: US 2002/0083150 A1
(43) Pub. Date: Jun. 27, 2002

(54) Accessing information from memory

(76) Inventor: Linden Minnick, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/750,234

(22) Filed: Dec. 27, 2000

(51) Int. Cl. G06F 3/00; G06F 15/167

(52) U.S. Cl. 709/216; 710/7

(57) ABSTRACT

Accessing information from memory includes allocating space in host memory to a buffer and copying the contents of a memory of a network interface controller into the buffer. The buffer is accessed in response to a request for information in the network interface controller memory. The contents of the memory are updated into the buffer if the contents of the memory are modified.

### BACKGROUND

The invention relates to accessing information from memory. A network interface controller (NIC), for example, may contain a memory device, such as an EEPROM (electronically erasable programmable read-only memory), to store information that is needed for functions such as managing a computer network or configuring the device. Applications running on a central processing unit (CPU) or the device driver may need to read or write information in the EEPROM. If the EEPROM shares a bus with another component needed for transmitting or receiving packets, EEPROM accesses can reduce overall network performance. For example, if a cryptographic chip on the NIC shares a common bus with the EEPROM, a software driver would have to switch access to the common bus between the cryptographic chip and the EEPROM, which is an expensive (i.e. time-consuming) operation. It is likely that the driver will need to reset the NIC in order to make the switch, which also causes transmitted packets to be discarded. The discarded packets may need to be retransmitted later.

### BRIEF DESCRIPTION OF THE DRAWINGS

FIG. 1 illustrates a network configuration.

FIG. 2 is a flow diagram illustrating a method of accessing memory.

### DETAILED DESCRIPTION

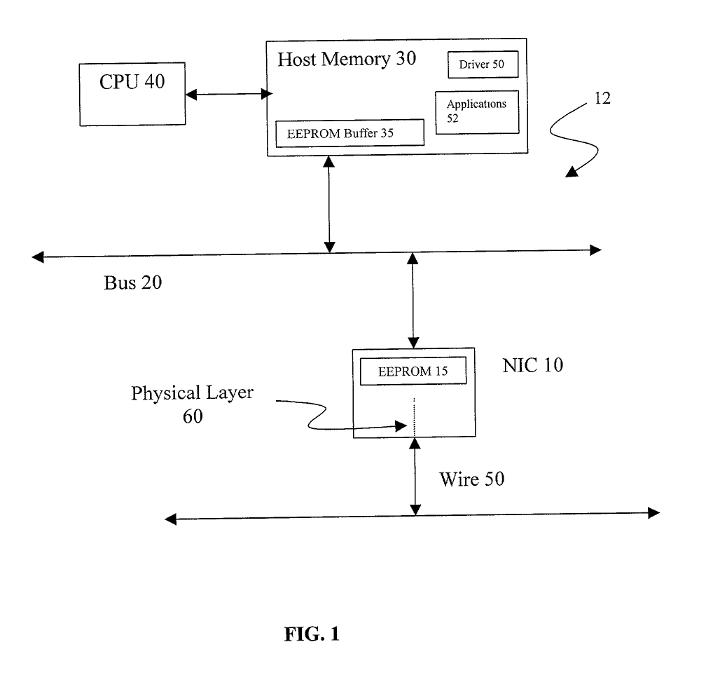

As shown in FIG. 1, a system 12 that includes a NIC 10 containing an EEPROM 15 is coupled to a bus 20. A host memory 30 also is coupled to the bus 20. A CPU 40 is coupled to the host memory 30.

Information in the EEPROM 15 can be accessed efficiently by allocating space to an EEPROM buffer 35 in the host memory 30 and initializing the EEPROM buffer 35 by copying the entire contents of the EEPROM 15 into the EEPROM buffer 35. The contents of the EEPROM 15 can then be accessed by the CPU 40 from the EEPROM buffer 35. The EEPROM 15 and the buffer 35 are small enough, for example, 64 or 256 bytes, that the entire contents of the EEPROM can be stored in the buffer in the host memory 30. A software device driver 50 residing in the host memory 30 and running on the CPU 40 can store the contents of the EEPROM 15 in the EEPROM buffer 35.

Whenever the device driver needs to modify the contents of the EEPROM 15, the device driver also updates the contents of the EEPROM buffer 35. If an application 52 modifies the EEPROM 15 through the driver 50, the EEPROM buffer 35 is correspondingly modified by the driver. If the driver 50 has given up control of the EEPROM 15 to another application 52 that modifies the content of the EEPROM 15, then the EEPROM buffer 35 is reinitialized by copying the entire contents of the EEPROM into the buffer. Since an EEPROM is read much more often than it is modified, this method has the effect of reducing direct EEPROM accesses and replacing them with EEPROM buffer accesses.

If the driver 50 operates in a Network Driver Interface Specification (NDIS) environment, the driver, called an NDIS miniport driver, should meet the following two requirements in order to be certified. First, the miniport driver initialization, which includes allocating part of the host memory 30 to the EEPROM buffer 35, should be completed in less than one second. Second, the NDIS miniport driver 50 should not spend more than one second at an interrupt request level (IRQL) that is a level above the lowest level of priority called PASSIVE LEVEL. An operation at the PASSIVE LEVEL can take as much time as necessary.

One implication of the first requirement is that the contents of the EEPROM 15 may not be read into the EEPROM buffer 35 at the time of the driver initialization. Otherwise, the slow access time of the EEPROM 15 may cause the driver 50 to exceed the time constraint. Thus, the content of the EEPROM 15 is preferably copied into the EEPROM buffer 35 after the driver initialization. That is, the EEPROM buffer 35 is initialized after the driver initialization.

An implication of the second requirement is that the driver 50 should ensure that initializing the EEPROM buffer 35, which is a slow process, is conducted at PASSIVE LEVEL. This means that initializing the EEPROM buffer should not occur concurrently with other asynchronous time-consuming events such as physical layer (PHY) initialization.

The PHY initialization refers to initialization of a physical layer 60, a portion of the NIC 10, that is in direct contact with a wire 50. The PHY initialization may take more than a second to complete. Since PHY initialization must occur at an IRQL higher than PASSIVE LEVEL, it must be broken into pieces of work (phases) that each take less than one second to complete. The NDIS miniport driver should ensure that the initialization of the EEPROM buffer does not occur during any of the phases of PHY initialization. This would cause PHY initialization to fail the second requirement described above. Therefore, initialization of the EEPROM buffer 35 should occur after the PHY initialization.

The miniport driver 50 running on the CPU 40 can provide an interface for other applications 52 residing in the host memory 30 to access the NIC 10 that the driver controls. Those other applications 52 may modify the contents of the EEPROM 15. For example, the driver 50 can communicate with an application 52, which initiates both ADAPTER_STOP and ADAPTER_START calls. The ADAPTER_STOP call directs the driver 50 to stop interacting with the NIC 10 so that the application 52 on the system can access the NIC. The application 52 may perform some diagnostic tests on or program the EEPROM 15, thereby modifying the contents of the EEPROM.

Once the application has finished interacting with the NIC 10, the application 52 makes an ADAPTER_START call. The driver 50 then reacquires control of the NIC 10 and can transmit and receive normally. The driver 50 reinitializes the EEPROM buffer 35 in the host memory 30 as part of the ADAPTER_START routine to copy the modified contents of the EEPROM 15 into the EEPROM buffer 35. This is done because the EEPROM 15 may have been modified by the application 52 while it had control of the NIC 10.

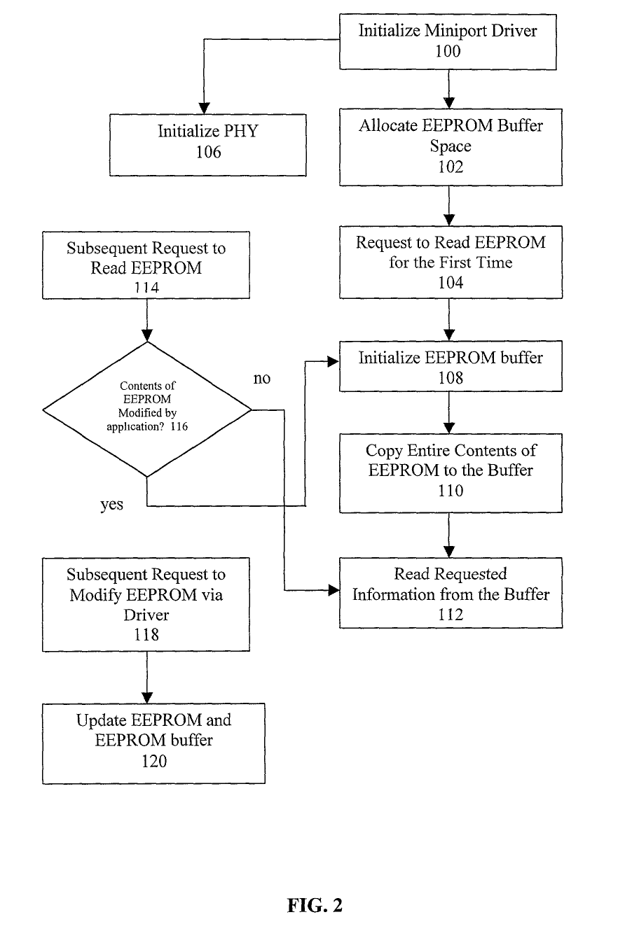

FIG. 2 shows how the EEPROM buffer 35 can be initialized and accessed. The miniport driver initialization is conducted 100 and includes allocating 102 memory space to the EEPROM buffer 35 in the host memory 30. The PHY initialization is conducted 106 asynchronously at an IRQL above PASSIVE LAYER after the driver initialization but before the initialization of the EEPROM buffer 35.

When there is a call to read 104 the EEPROM 15 by an application 52 on the host memory 30 via the driver for the first time after PHY initialization, the EEPROM buffer 35 is initialized 108. The entire contents of the EEPROM 15 are copied 110 into the EEPROM buffer 35. Applications that may change the contents of the EEPROM 15 include PROSet (a configuration, installation, and diagnostic Utility)and Alert on LAN (Alert on local area network) software. As previously discussed, the buffer initialization should not conflict with other asynchronous time-consuming events. The requested information then is read 112 from the EEPROM buffer 35.

Subsequent requests 114 to read the EEPROM 15 by an application can be directed to the EEPROM buffer 35, thereby allowing the requested information to be accessed efficiently.

If the driver 50 gives control over to another application 52 that modifies 116 the contents of the EEPROM 15, the EEPROM buffer 35 is reinitialized 108 by copying the modified contents of the EEPROM into the buffer. If the contents of the EEPROM 15 are modified 118 by another application on the host memory 30 through the driver 50, the driver updates 120 the EEPROM buffer 35 when the driver modifies the EEPROM 15. The updates of the EEPROM buffer 35 can be conducted independent to any read requests.

Because accessing the EEPROM buffer 35 in the host memory 30 is generally more efficient than accessing the EEPROM 15 in the NIC 10, a greater speed can be achieved by this approach. Also, this arrangement can afford greater performance efficiency because the driver 50 running on the CPU 40 need not access the bus 20 and communicate with the EEPROM 15. Furthermore, less erratic behavior within the network can be achieved because information in the EEPROM 15 is accessed from the EEPROM buffer 35, so switching of a common bus shared by the EEPROM and another component on the NIC 10 need not be done as often.

The foregoing techniques can be implemented in a program executable on a computer system. The program can be stored on a storage medium readable by a general or special purpose programmable computer system. The storage medium is read by the computer system to perform functions described above.

Other implementations are within the scope of the following claims.

What is claimed is:

1. A method comprising:
allocating space in a host memory for use as a buffer;
copying contents of a memory of a network interface controller into the buffer; and
accessing the buffer in response to a request for information in the network interface controller memory.

2. The method according to claim 1 further comprising:
modifying the contents of the network interface controller memory; and
correspondingly modifying the contents of the buffer.

3. The method according to claim 1 further comprising:
initializing a device driver in a Network Driver Interface Specification environment to allocate the space in the host memory in less than a second.

4. The method according to claim 3 comprising:
initializing the buffer to store the contents of the network interface controller memory wherein initializing the buffer occurs at a different time from the driver initialization.

5. The method according to claim 1 comprising:
initializing a physical layer; and
subsequently initializing the buffer to store the contents of the network interface controller memory.

6. The method according to claim 1 wherein the network interface controller memory comprises an EEPROM.

7. A method comprising:
copying contents of a network interface controller memory into a buffer in host memory;
recopying the contents of the network interface controller memory into the buffer if the contents of the network interface controller memory are modified; and
accessing the buffer in response to a request for information in the network interface controller memory.

8. The method according to claim 7 further comprising:
initializing a driver to allocate memory space to the buffer.

9. The method according to claim 8 further comprising:
initializing the driver in a Network Driver Interface Specification environment in less than a second.

10. The method according to claim 8 further comprising:
initializing the buffer at a time different from the driver initialization.

11. The method according to claim 7 further comprising:
initializing the buffer to store the contents of the network interface controller memory in response to a first request to read the contents of the network interface controller memory.

12. An apparatus comprising:
a network interface controller containing a memory;
a bus coupled to the controller;
a host memory coupled to the bus and having space allocated for use as a buffer; and
a processor coupled to the host memory and configured to:
copy contents of the network interface controller memory into the buffer; and
access the buffer in response to a request for information in the network interface controller memory.

13. The apparatus according to claim 12 wherein the processor is further configured to:
modify the contents of the network interface controller memory; and
correspondingly modify the contents of the buffer.

14. The apparatus according to claim 12 wherein the processor is further configured to:
initialize a device driver in a Network Driver Interface Specification environment to allocate the space in the host memory in less than a second.

15. The apparatus according to claim 14 wherein the processor is further configured to:
initialize the buffer to store the contents of the network interface controller memory, wherein the buffer initialization occurs at a different time from the driver initialization.

16. The apparatus according to claim 12 wherein the processor is further configured to:
initialize a physical layer; and
subsequently initialize the buffer to store the contents of the network interface controller memory.

17. The apparatus according to claim 12 wherein the network interface controller memory comprises an EEPROM.

18. An apparatus comprising:
a network interface controller containing a memory;
a bus coupled to the controller;
a host memory coupled to the bus; and
a processor coupled to the host memory; wherein the processor is configured to:
copy contents of the network interface controller memory into a buffer in the host memory;
access the buffer in response to a request for information in the network interface controller memory; and
recopy the contents of the network interface controller memory into the buffer if the contents of the network interface controller memory are modified.

19. The apparatus according to claim 18 wherein the processor is further configured to:
initialize a driver in a network driver interface specification environment to allocate memory space to the buffer in less than a second.

20. The apparatus according to claim 19 wherein the buffer is initialized at a time different from the driver initialization.

21. The apparatus according to claim 18 wherein the processor is further configured to:
initialize the buffer to store the contents of the network interface controller memory in response to a first request to read the contents of the network interface controller memory.

22. An article comprising a computer-readable medium that stores computer-executable instructions for causing a computer system to:
allocate space in a host memory for use as a buffer;
copy contents of a memory of a network interface controller into the buffer; and
access the buffer in response to a request for information in the network interface controller memory.

23. The article according to claim 22 further including instructions for causing the computer system to:
modify the contents of the network interface controller memory; and
correspondingly modify the contents of the buffer.

24. The article according to claim 22 further including instruction for causing the computer system to:
initialize a device driver in a network driver interface specification environment to allocate the space in the host memory in less than a second.

25. The article according to claim 24 further including instruction for causing the computer system to:
initialize the buffer to store the contents of the network interface controller memory wherein initializing the buffer occurs at a different time from the driver initialization.

26. The article according to claim 22 further including instructions for causing the computer system to:
initialize a physical layer; and
subsequently initialize the buffer to store the contents of the network interface controller memory.

27. An article comprising a computer-readable medium that stores computer-executable instructions for causing a computer system to:
copy contents of a network interface controller memory into a buffer in host memory;
recopy the contents of the network interface controller memory into the buffer if the contents of the network interface controller memory are modified; and
access the buffer in response to a request for information in the network interface controller memory.

28. The article according to claim 27 further including instructions for causing the computer system to:
initialize a driver in a Network Driver Interface Specification environment to allocate memory space to the buffer in less than a second.

29. The article according to claim 27 further including instructions for the computer system to:
initialize the buffer to store the contents of the network interface controller memory in response to a first request to read the contents of the network interface controller memory.
